(19) United States
(12) Patent Application Publication
(10) Pub. No.: US 2012/0087113 A1
(43) Pub. Date: Apr. 12, 2012

(54) HYBRID LIGHTING SYSTEM WITH LED ILLUMINATION SOURCES

(76) Inventor: Thomas David McClellan, Santa Cruz, CA (US)

(21) Appl. No.: 12/902,078

(22) Filed: Oct. 11, 2010

(51) Int. Cl. F21S 8/04; F21V 29/00

(52) U.S. Cl. 362/147

(57) ABSTRACT

A lighting system which includes an enclosure extending from the roof of a building to within the interior of a building. The enclosure has a top opening covered by a skylight, and a bottom opening covered by a panel within the building interior, and there is at least one LED heat-sink assembly positioned within the enclosure.

Co-pending non-provisional U.S. patent application Ser. No. 12/902,041, entitled HEAT SINK AND LED COOLING SYSTEM is incorporated by reference in the present application, as well as U.S. Pat. No. 7,736,014 to Jerome Blomberg, entitled HYBRID LIGHTING SYSTEM, which is also incorporated by reference herein.

### TECHNICAL FIELD

The present invention relates to illumination sources and more particularly to combined passive solar and electric lighting systems which utilize LED lighting.

### BACKGROUND ART

Skylights have been used for centuries by architects to allow or to direct sunlight through ports in a building's roof to illuminate interiors of buildings. Early skylights were basically windows in the building's ceiling. However, the amount of light entering is highly dependent on weather conditions, time of day, time of year, cloud movement, shadowing from trees or other structures, etc., so that obtaining a consistently adequate light level may be difficult to achieve. On the other extreme, in warm climates, the light intensity may be too bright, and there may significant unwanted heat intrusion.

In answer to these concerns, more sophisticated illumination devices have been designed with movable elements, or with supplemental illumination devices to produce “hybrid” systems, which use both solar and electric lighting sources. These may also include shutters or louvers, which can shut out excessive light and heat.

One such hybrid system is disclosed in U.S. Pat. No. 7,736,014 to Jerome O. Blomberg, entitled HYBRID LIGHTING SYSTEM which is incorporated by reference herein. This patent discloses a lighting apparatus comprising: a) a frame spanning the roof and interior of a building, the frame having a first opening at the building roof and a second opening opposed to the first opening at the building ceiling; b) a skylight at the first opening; c) a reflective lining between the first and second openings; d) a light diffuser at the second opening; and e) at least one artificial light source located between the skylight and the diffuser; where the artificial light source is positioned at the frame periphery.

Blomberg generally discloses use of artificial lighting, but does not specifically discuss the use of Light-Emitting Diodes (LEDs) as the lighting source to be combined with solar lighting. LEDs have many advantages over incandescent and fluorescent lighting, in terms of efficiency, long term costs and environmental benefits, and would constitute a substantial improvement over other lighting sources in a hybrid skylight application. In addition, being semiconductor devices, programmable control and finer gradation of illumination is possible.

Light-Emitting Diodes (LEDs) are semiconductor light sources, which have many practical applications due to their longer lifetime, faster switching, smaller physical size, greater durability and higher energy efficiency.

When a light-emitting diode is forward biased, electrons (negative charges) recombine with holes (positive charges), which releases energy in the form of photons. The energy difference within the diode produces photons of different wavelengths, for different colors, which do not require color filters to produce. LEDs are solid state devices and if operated at low currents and at low temperatures, are subject to very limited wear and tear. Typical lifetimes are estimated to be 35,000 to 50,000 hours of useful life, compared to 10,000 to 15,000 hours for fluorescent tubes, and 1,000-2,000 hours for incandescent light bulbs. LEDs are also less fragile than fluorescent and incandescent bulbs, and are less susceptible to damage by external vibration.

LEDs produce more light per watt than incandescent bulbs, and are ideal for use in applications that are subject to frequent on-off cycling, unlike fluorescent lamps that burn out more quickly when cycled frequently. LEDs can very easily be dimmed continuously unlike fluorescent lamps which require a certain threshold voltage to function.

LEDs have been found to have significant environmental benefits compared to other alternatives. It has been estimated that a building's carbon footprint from lighting can be reduced by 68% by exchanging all incandescent bulbs for new LEDs. LEDs are also non-toxic compared to compact fluorescent, which contains traces of mercury. Organic light emitting diodes (OLEDs) can be produced that use an organic compound as the emitting layer material of the LED, and which can be a polymer.

Performance of LEDs is temperature dependent, and LED light output actually increases at cold temperatures. LEDs do not generate as much heat as incandescent bulbs, by not producing invisible light in the infrared range, but they do produce internal heat which must be dissappated if the LED is to maintain good performance. Over-heating of the LED is a major factor in device failure. Therefore, heat-sinks are necessary to maintain long life of the LED.

A cooling system for improved heat-transfer from LEDs is disclosed in co-pending non-provisional U.S. patent application Ser. No. 12/902,041 entitled HEAT SINK AND LED COOLING SYSTEM, which is incorporated by reference in the present application. The LED cooling systems and assemblies disclosed in this application provide many advantages over previous LEDs and LED heat sinks, and are considered ideal for use in an improved hybrid lighting system which utilizes LED lighting.

Thus, there is need for a hybrid lighting system which includes LED lighting utilizing LED cooling systems which are long lasting, reliable, inexpensive to operate and environmentally beneficial.

### DISCLOSURE OF INVENTION

Briefly, one preferred embodiment of the present invention is a lighting system which includes an enclosure extending from the roof of a building to within the interior of a building. The enclosure has a top opening covered by a skylight, and a bottom opening covered by a panel within the building interior, and there is at least one LED heat-sink assembly positioned within the enclosure.

An advantage of the present invention is that it uses LED lighting, which is more efficient than other types of lighting.

Another advantage of the present invention is that it uses LED lighting, which is more environmentally beneficial than other types of lighting.

A further advantage of the present invention is that it uses LED lighting, which is almost continuous dimmable and more finely controllable than other forms of lighting.

And another advantage of the present invention is it preferably uses LED cooling systems, which produce better cooling of LEDs, and thus better efficiency and longer device lifetimes.

Yet another advantage of the present invention is that it provides a lighting system that can be wirelessly controlled by a variety of wall mounted and hand-held devices including laptops, PDAs and other personal electronics.

A further advantage of the present invention is that it includes louvers, which are reflective louvers that produce higher lighting efficiencies.

A yet further advantage of the present invention is that it may include an occupancy sensor, which can control lighting operations to reduce energy usage when a room is unoccupied.

Additional advantages of the present invention are that the operation of the lighting system may be controlled by an astronomical clock, and may also be operated in conjunction with a GPS system.

An additional advantage is the lighting controller for the LEDs can be programmed to automatically raise or lower the lights according to a predetermined foot-candle reading.

Another advantage is the control system can open and close the reflective louver to give the required foot-candle light output from the solar source. Sometimes the solar source can be too bright.

Additionally, the reflective louvers can be closed at night to increase light output and decrease light pollution to the dark sky.

Additionally, the Hybrid system can work with existing building control system.

Additionally, the Hybrid can be customized for each customer.

Additionally, the Hybrid system can be customized for each different are in a building. Some lights can work independently and some can be programmed to work together, including the complete building working together.

Additionally, the system can be controlled remotely from an internet connection.

Additionally, the system can have a wireless access for the power company to control under contract conditions to enable the customer to have a negotiated rate of power. Sometimes a power company has a limit on power and needs to cut back in some areas of their power grid. This enables them to cut back a negotiated amount for example 10-50% without turning power off. The customer can keep working.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIG. 1 shows an isometric cut-away view of the lighting system of the present invention;

FIG. 2 shows a side elevation cut-away view of the lighting system of the present invention;

FIG. 3 shows an isometric view of an angled LED cooling system as used in the lighting system of the present invention;

FIG. 4 shows an isometric exploded view of an angled LED heat-sink assembly as used in the lighting system of the present invention;

FIG. 5 shows an isometric view of a straight LED cooling system as used in the lighting system of the present invention;

FIG. 6 shows an isometric exploded view of a straight LED heat-sink assembly as used in the lighting system of the present invention;

FIG. 7 shows a side elevation view of a heat sink as used in the lighting system of the present invention; and

FIGS. 8-9 show side elevation cut-away views of the lighting system of the present invention using straight LED cooling systems.

### DETAILED DESCRIPTION OF THE PREFERRED EMBODIMENTS

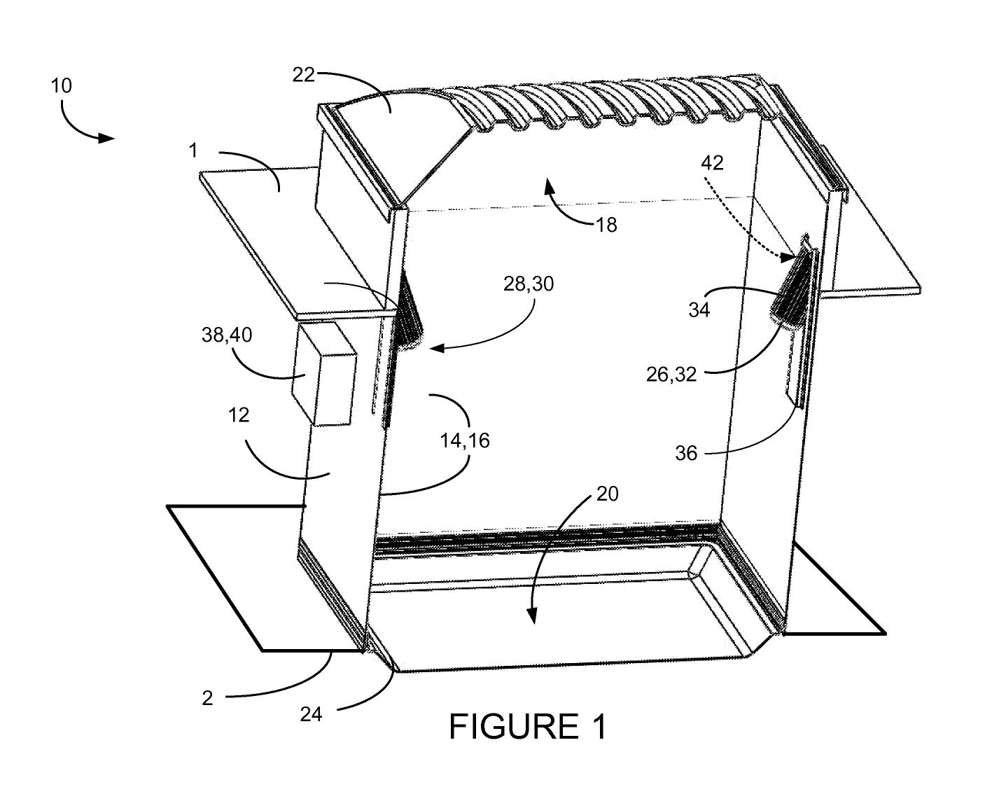

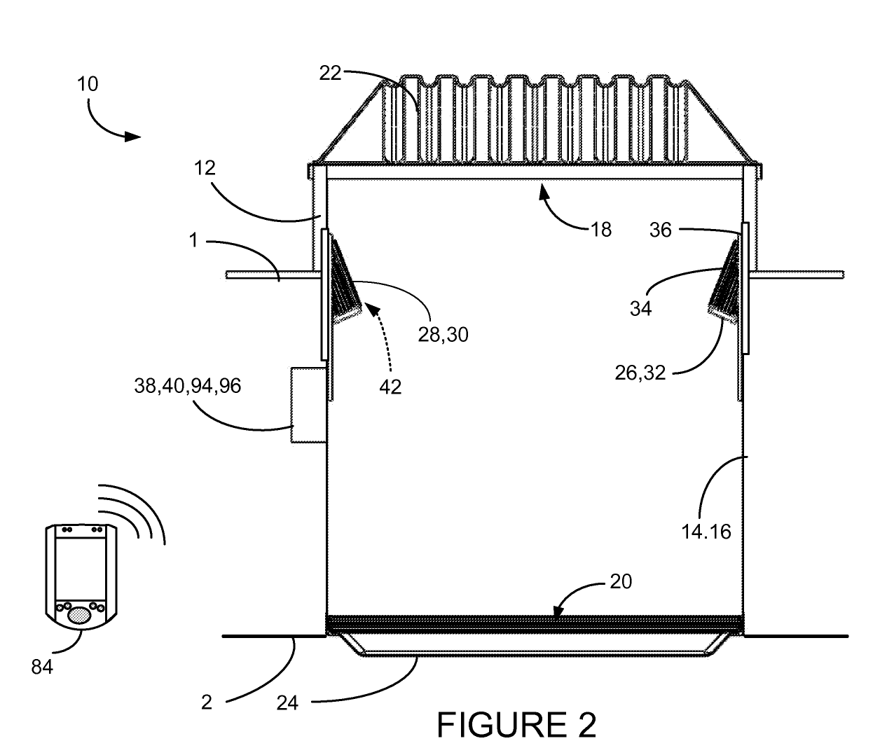

The present invention is an integrated solar and LED lighting system, which will be referred to by the reference number 10, and thus shall be referred to as lighting system 10. The lighting system 10 can include digital controls, and wireless communications between the controller and the LED assemblies. A first preferred embodiment of the lighting system 10 and its elements are illustrated in FIGS. 1-2.

FIG. 1 shows an isometric cut-away view of the present lighting system 10. The lighting system 10 includes an enclosure 12, which can be in the form of a tube or rectangular box, having side walls 14, which are preferably reflective walls 14. There is a top opening 18 and a bottom opening 20, wherein the top opening 18 faces the sky and the bottom opening 20 faces the interior of the building in which it is installed. The top opening 18 is covered by a skylight 22, and a transparent or translucent panel 24, which may have the form of a diffusion panel, lens or window, covers the bottom opening 20. The skylight 22 and panel 24 are preferably glazed to prevent heat loss or gain into the room below.

The lighting system 10 in practice is mounted spanning the roof 1 and interior ceiling 2 of the building, with the top opening 18 being located generally at, or above, the level of the roof 1, and the bottom opening 20 located generally at, or below, the level of the interior ceiling 2. The reflective walls 16 of the enclosure 12 are located between the top opening 18 and bottom opening 20, and can be fabricated to extend any distance between the roof 1 and the ceiling 2.

LED lights 26 included in LED modules 32 are positioned within the enclosure 12, and in the first preferred embodiment, preferably include angled LED heat-sink assemblies 28 or angled LED cooling systems 30 as shown in FIGS. 1 and 2.

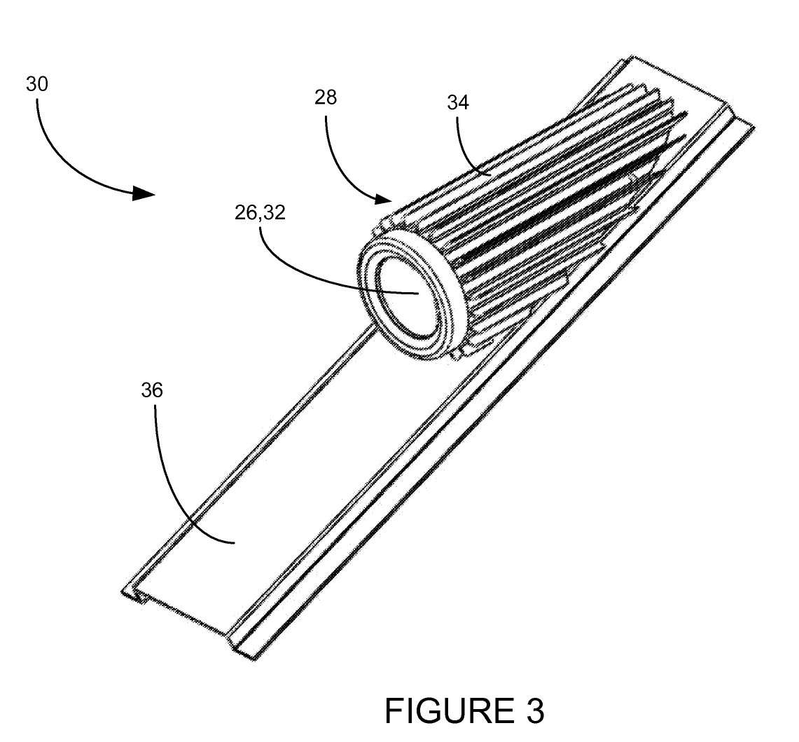

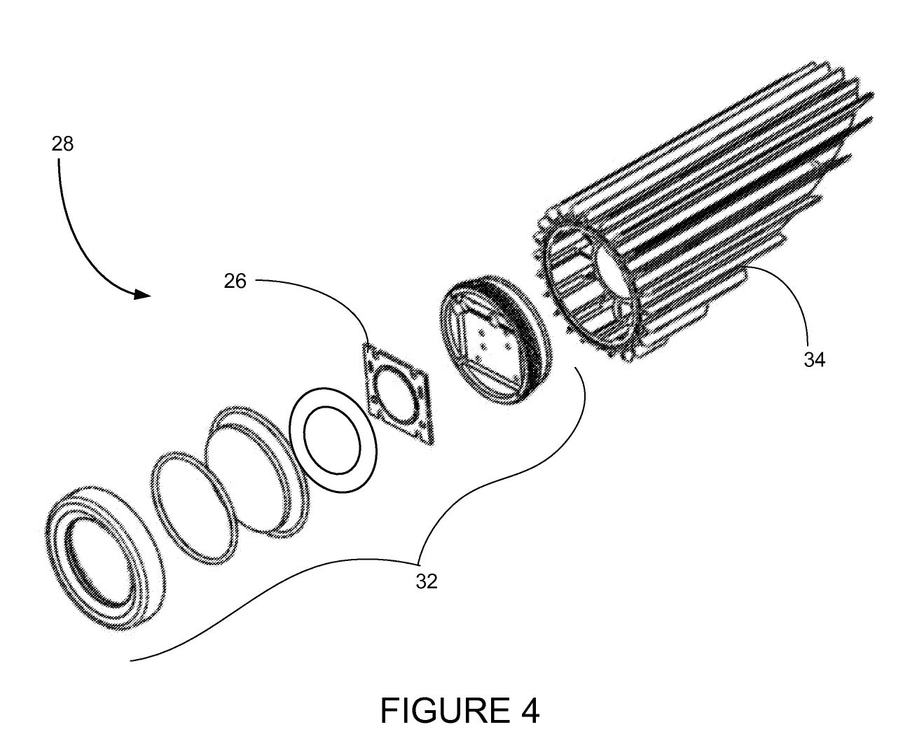

The angled LED cooling system 30 and angled LED heat sink assembly 28 both of which use an angled heat sink 34, are shown in FIGS. 3 and 4 respectively. Each angled LED heat-sink assembly 28 includes an LED module 32 that has an LED 26, and a specially configured angled heat-sink 34. The angled heat-sink 34 has been carefully designed to configure multiple parameters for improved heat transfer from the LED module 32, as described in the referenced U.S. patent application Ser. No. 12/902,041, which has been incorporated by reference. An LED cooling system 30 also includes a cooling frame 36, which additionally helps to route cooling air to the LED 26 and conduct heat away from the LED 26. The cooling frame can be either a planar frame or a corner frame, also as discussed in U.S. patent application Ser. No. 12/902,041.

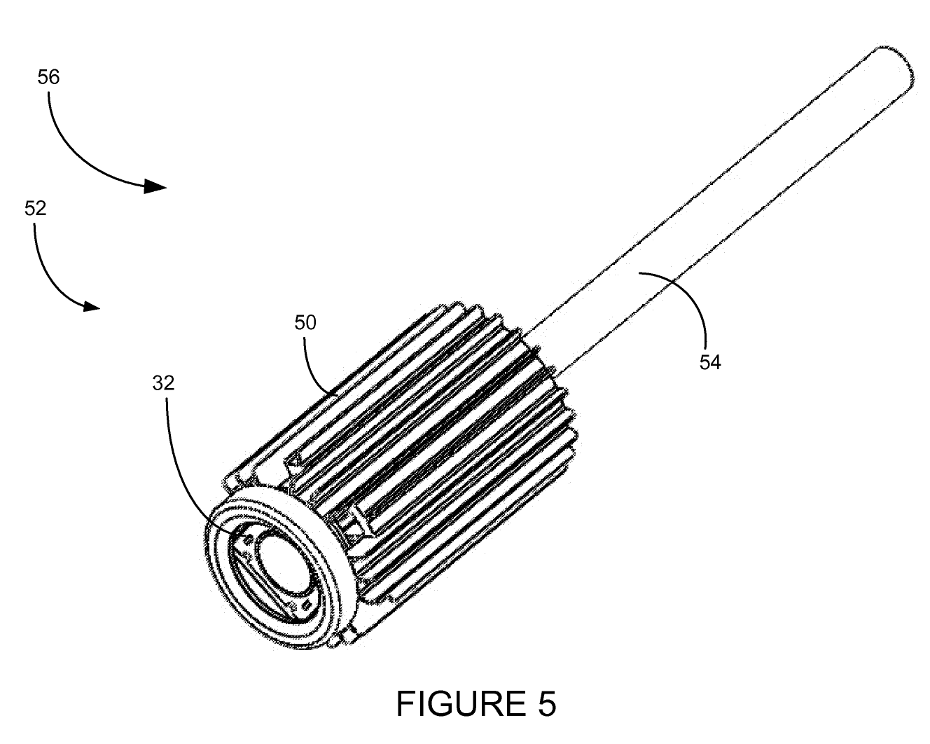

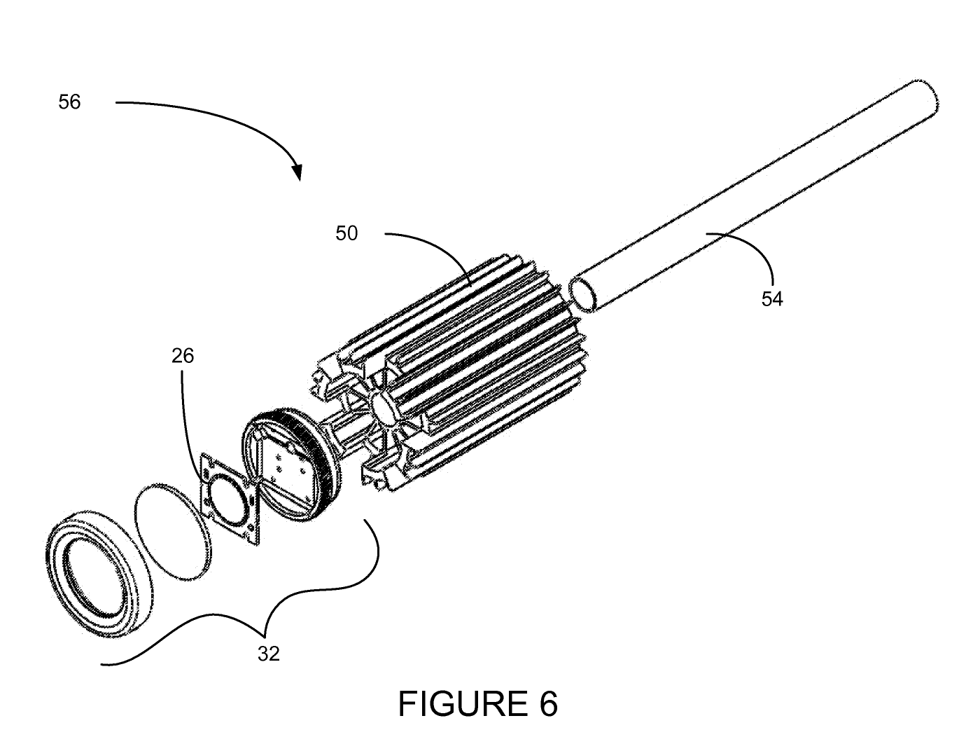

As shown in FIGS. 5 and 6, the heat sink housing of the LED cooling system may also be configured as a straight heat sink 50. When coupled with an LED module 32, a straight LED heat sink assembly 52 is produced, and if a cooling pipe 54 is also included, a straight LED cooling system 56 is completed.

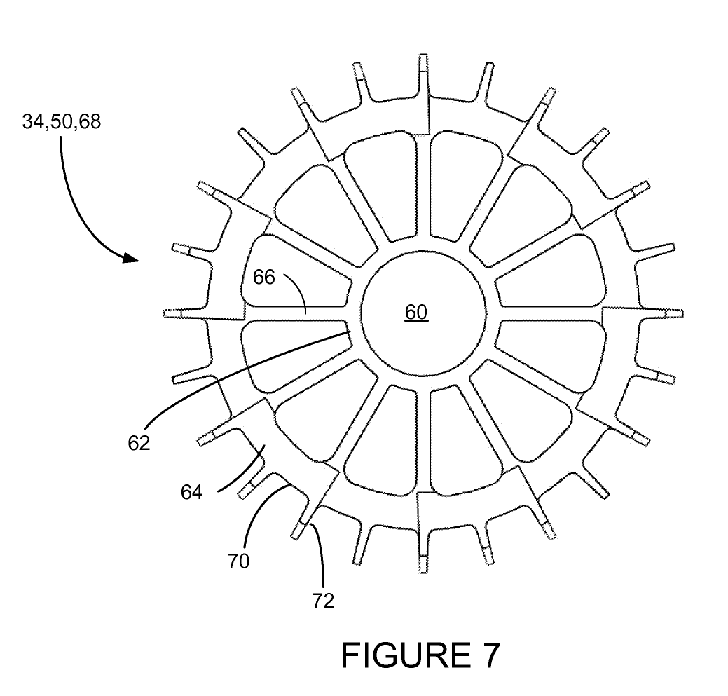

FIG. 7 shows a front elevation view of a heat sink, which can be either an angled heat sink 34 or a straight heat sink 50. The heat sink housing 34, 50 is configured with a central bore 60, which is surrounded by an inner tube 62. A larger outer tube 64 is concentric with the inner tube 62, and internal fins 66 extend between the inner tube 62, and the outer tube 64. The configuration of an inner tube 62, an outer tube 64, and internal fins 66 which connect between the inner tube 62 and the outer tube 64, shall be referred to as a finned concentric tube configuration 68. The outer surface 70 of the outer tube 64 includes a number of external fins 72, which are preferably spaced in a regular fashion around the circumference of the outer tube 64. Applicant has found that this finned concentric tube configuration 68 to be especially effective at providing excellent heat transfer from the LED module 32. The configuration of various parameters such as fin height, width and spacing are discussed in referenced U.S. patent application Ser. No. 12/902,041, which has been incorporated by reference.

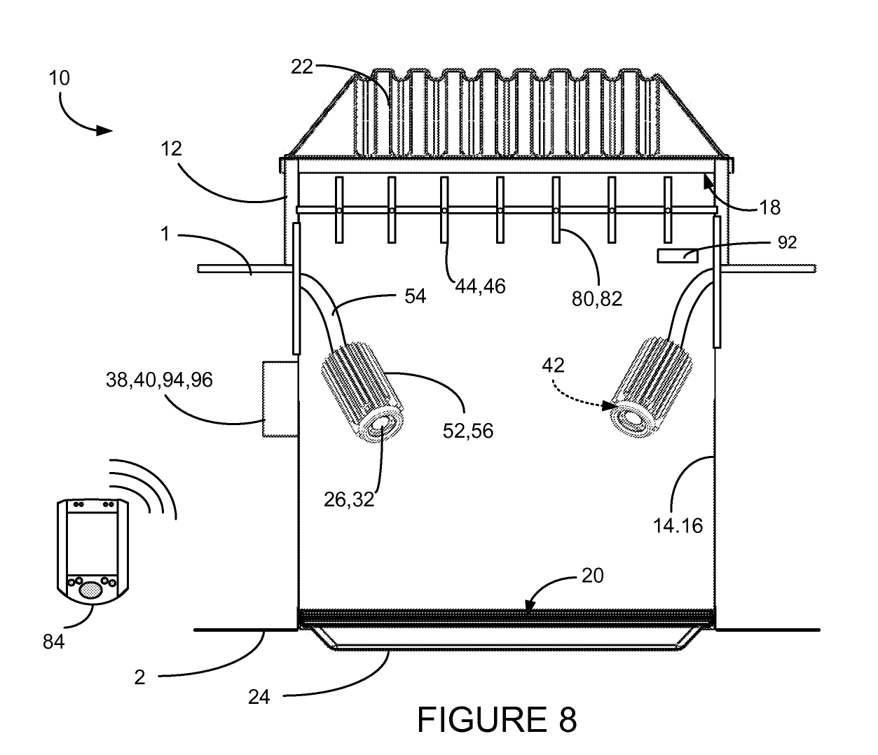

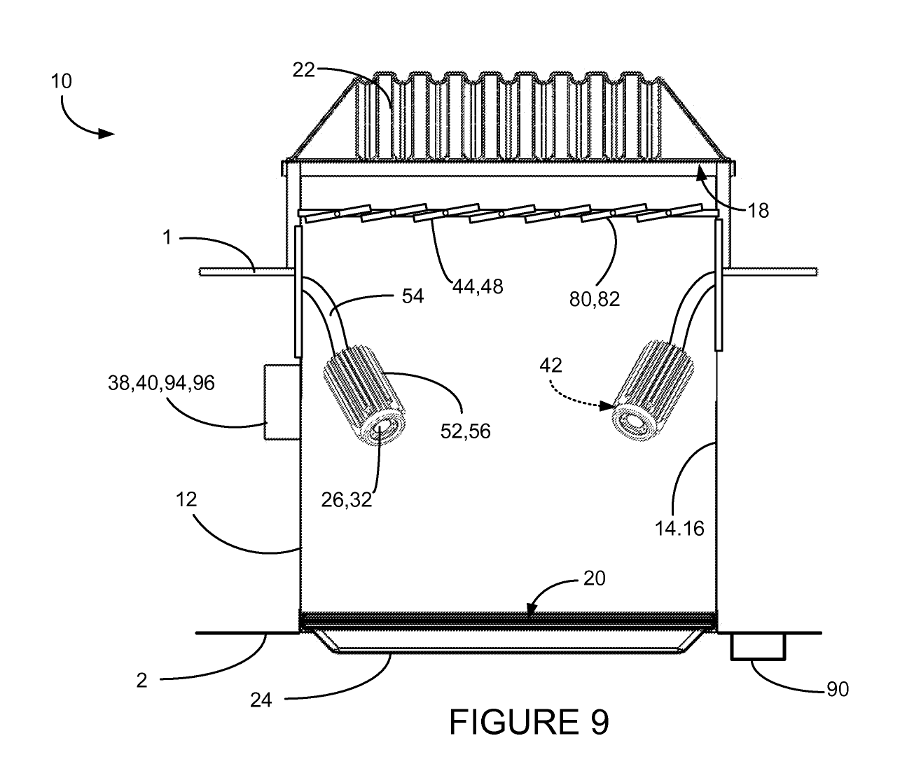

FIGS. 8 and 9 show a lighting system 10, which includes two of the straight LED heat-sink assemblies 52 or straight LED cooling systems 56 as lighting sources. As discussed above, each straight LED cooling system 56 includes a straight LED assembly 52 and a cooling pipe 54 to provide an air cooling passage to the LED module 32. As before, the LEDs are wirelessly controlled, with a common power supply 38, a wireless module controller 40 and a wireless receiver 42 in each LED cooling system 56. A number of wireless devices, including wall mounted, hand held devices, and personal electronics, which include laptops, PDAs, cell phones, etc. can be used to communicate, program and control components of the lighting system 10, both individually and collectively. These wireless devices are represented by element wireless device 84 in FIGS. 2 and 8. Of course, conventional wired controls are also possible to use with the controller 40.

A further feature is shown with the addition of louvers 44, which are shown in an open position 46 in FIG. 8, and in a closed position 48 in FIG. 9. The closing and opening of the louvers 44 is actuated by an electric motor (not shown), which is another of the components of the lighting system 10 which can also be controlled wirelessly. The louvers 44 are preferably coated with a reflective coating 80 to provide reflective louvers 82. It is estimated that light output from the LEDs is increased by 20% with the use of the reflective louvers 82 over systems with no louvers.

Another feature included in the preferred embodiment of the present lighting system 10 is an occupancy sensor 90, which can be in the form of a conventional motion sensor, or a light sensor that can measure the foot-candles of the interior building. This sensor will send a signal to the wireless controller to raise or lower the light levels according to the preprogrammed level for each application. The occupancy sensor 90 provides the advantage that the lighting system 10 can shut off the LED lights 26 automatically when a room is unoccupied, thus saving on electricity costs, and can turn on lights automatically when a person enters the room, if so programmed. Also preferably included is a light level sensor, which can sense the fluctuations in light levels and brighten or dim the LED light levels in order to compensate for deficiencies or abundances in the solar light which enters the skylight. This sensor is preferably a photo-diode photocell 92 placed below or above the louvers 44.

As indicated in FIGS. 2 and 8, the lighting system 10 can also include an astronomical clock system 94, which keeps track of time without the use of photocells, so the LEDs 26 can be turned on or off at any specified time. GPS system 96 can also be included to allow the LED modules 32 to be tracked by location using a GPS system.

Generally speaking, the photo-diode photocell creates a signal that goes to a control board, which can adjust the louvers, and if there is insufficient daylight, a circuit activates one or more LED lamps until the appropriate lighting level is achieved. Being digital devices, the LEDs can be adjusted in levels between 0 to 255, or even more to produce gradations in lighting which may almost be beyond human ability to discern. Thus, LEDs provide a continuously dimmable illumination which other forms of illumination may not.

It is to be understood that while angled LED heat-sink assemblies 28 or angled LED cooling systems 30 are preferred, this is not to be construed as a limitation, and conventional LEDs, with or without conventional heat-sinks, may also be used. It is however expected that the use of the preferred angled LED assemblies 28 or angled LED cooling systems 30 will increase performance and the useful life-span of the LEDs and is therefore to be preferred in the lighting system 10.

Many variations in the present lighting system 10 are possible. As discussed above, LED modules 32 can be controlled by a wireless programmable control system to adjust the light according to data from occupancy sensors 90 and photo sensors 92 or wireless devices 84 activated by the user.

Generally speaking, each LED module can be controlled individually or together in groups as specified by the user. The LED module controller can be programmed remotely by a USB wireless device plugged into a laptop or desktop, or the LED module controller can be controlled by a hand held wireless device to turn off, on, dim up or down.

The LED module controller can be controlled and programmed by a Wi-Fi control by a wireless wall unit, by a Blackberry or other hand held device. The LED module controller can communicate with other controllers in the same building or outside area. The LED module can be controlled with an astronomical clock system to keep track of time without the use of photocells, so the LEDs turn on or off at any specified time. The LED controllers can have a GPS system to allow them to be tracked by location using a GPs system. The LED module controller can talk with a remote lighting sensor to automatically adjust to the amount of daylight coming into the room or area. The LED module controller can adjust to compensate for override controls by the user.

The LED cooling systems or modules can be mounted alone on a canopy, on a pendent down rod, or on a track. The LED cooling systems or modules can be mounted in groups of 2, 3, 4, 5, 6, 8, 12 etc. The LEDs can be controlled individually or collectively together in a group.

While various embodiments have been described above, many alternatives, modifications and variations will be apparent to those skilled in the art, and it should be understood that they have been presented by way of example only, and not limitation. Various changes may be made without departing from the spirit and scope of this invention.

### INDUSTRIAL APPLICABILITY

The present hybrid lighting system with LED lighting 10 is well suited generally for providing controlled interior illumination for many types of buildings and structures.

LEDs are solid state devices and if operated at low currents and at low temperatures, are subject to very limited wear and tear. Typical lifetimes are estimated to be 35,000 to 50,000 hours of useful life, compared to 10,000 to 15,000 hours for fluorescent tubes, and 1,000-2,000 hours for incandescent light bulbs. LEDs are also less fragile than fluorescent and incandescent bulbs, and are less susceptible to damage by external shock. LEDs produce more light per watt than incandescent bulbs, and have been found to have significant environmental benefits compared to other alternatives. It has been estimated that a building's carbon footprint from lighting can be reduced by 68% by exchanging all incandescent bulbs for new LEDs.

Thus a hybrid system that combines solar and LED illumination can provide substantial energy savings and environmental benefits, and great industrial applicability.

In practice, the present lighting system 10 includes an enclosure 12, which can be in the form of a tube or rectangular box, having side walls 12, which are preferably reflective walls 14. There is a top opening 18 covered by a skylight or skylight 22, which faces the sky, and a bottom opening 20, a transparent or translucent panel 24, which may have the form of a diffusion panel, lens or window, which faces the interior of the building in which it is installed. The skylight 22 and panel 24 may be glazed to prevent heat loss or gain into the room below.

The lighting system 10 is generally mounted spanning the roof 1 and interior ceiling 2 of the building, with the top opening 18 being located generally at, or above, the level of the roof 1, and the bottom opening 20 located generally at, or below, the level of the interior ceiling 2. The reflective walls 16 of the enclosure 12 are located between the top opening 18 and bottom opening 20, and can be fabricated to extend any distance between the roof 1 and the ceiling 2.

LED lights 26 are positioned within the enclosure 12. Since the efficiency and life span of the LED is highly dependent on the operating temperature of the LED, proper cooling of the LED is very important to performance. Therefore, present system 10 preferably includes angled LED cooling systems 30 with angled LED heat-sink assemblies 28 or a straight LED cooling system 154, including a straight heat sink housing 150. These are disclosed in co-pending U.S. patent application Ser. No. 12/902,041, concerning heat sinks and cooling systems for LEDS, which has been incorporated herein by reference.

The angled LED cooling systems 30, preferably includes a cooling frame 14, of either the planar frame 94 or the corner frame 96 variety. The straight LED cooling system 56 preferably includes a cooling pipe 54 to provide an air cooling channel for cooling the LED module 34. Additionally, the straight LED cooling system 56 has internal channels to allow for additional cooling.

Both straight and angled LED cooling systems 30, 56 include heat sink housings 34, 50 having an inner tube 62, an outer tube 64, and internal fins 66 which connect between the inner tube 62 and the outer tube 64. This assertedly novel feature is referred to as a finned concentric tube configuration 68, and produces greatly improved heat transfer from the LEDs.

Louvers 44 are preferably provided which are coated with a reflective coating 80 to provide reflective louvers 82. The lighting system 10 also preferably includes an occupancy sensor 90, which provides the advantage that the lighting system 10 can shut off the LED lights 26 automatically when a room is unoccupied, thus saving on electricity costs, and can turn on lights automatically when a person enters the room, if so programmed. Also preferably included is a light level sensor, which can sense the fluctuations in light levels and brighten or dim the LED light levels in order to compensate for deficiencies or abundances in the solar light which enters the skylight. This sensor is preferably a photo-diode photocell 92 placed below the louvers 44.

The lighting system 10 can also include an astronomical clock system 94, which keeps track of time without the use of photocells, so the LEDs 26 can be turned on or off at any specified time. GPS system 96 can also be included to allow the LED modules 32 to be tracked by location using a GPs system.

Many variations in the present lighting system are possible. As discussed above, LED modules can be controlled by a wireless programmable control system to adjust the light according to other factors of daylight or occupancy.

Generally speaking, each LED module can be controlled individually or together in groups as specified by the user. The LED module controller can be programmed remotely by a USB wireless device plugged into a laptop or desktop, or the LED module controller can be controlled by a hand held wireless device to turn off, on, dim up or down. The use of digital controls provides optimal user control while maximizing energy savings.

The LED module controller can be controlled and programmed by a Wi-Fi control by a wireless wall unit, by a Blackberry or other hand held device. The LED module controller can communicate with other controllers in the same building or outside area. The LED module can be controlled with an astronomical clock system and can have a GPS system to allow them to be tracked by location using a GPs system. The LED module controller can communicate with a remote lighting sensor to automatically adjust to the amount of daylight coming into the room or area. The LED module controller can adjust to compensate for override controls by the user.

The LED cooling systems or modules can be mounted alone on a canopy, on a pendent down rod, or on a track. The LED cooling systems or modules can be mounted in groups of 2, 3, 4, 5, 6, 8, 12 etc. The LEDs can be controlled individually or collectively.

Additionally, the system can have a wireless access for the power company to control under contract conditions to enable the customer to have a negotiated rate of power. Sometimes a user's power company has a limit on power and needs to cut back in some areas of their power grid. This enables them to cut back a negotiated amount for example 10-50% without turning power off. The customer can keep working.

For the above, and other, reasons, it is expected that the lighting system 10 of the present invention will have widespread industrial applicability. Therefore, it is expected that the commercial utility of the present invention will be extensive and long lasting.

What is claimed is:

1. A lighting system comprising:
an enclosure extending from the roof of a building to within the interior of a building, said enclosure having a top opening covered by a skylight, and a bottom opening covered by a panel within the building interior; and
at least one LED heat-sink assembly positioned within said enclosure.

2. The lighting system of claim 1, wherein said at least one LED heat-sink assembly includes a heat sink which is of finned concentric tube configuration.

3. The lighting system of claim 2, wherein said at least one LED heat-sink assembly includes at least one angled LED heat-sink assembly.

4. The lighting system of claim 2, wherein said at least one LED heat-sink assembly includes at least one straight LED heat-sink assembly.

5. The lighting system of claim 2, wherein said at least one LED heat-sink assembly is included as part of at least one LED cooling system.

6. The lighting system of claim 5, wherein said at least one LED cooling system includes at least one angled LED cooling system.

7. The lighting system of claim 5, wherein said at least one LED cooling system includes at least one straight LED cooling system.

8. The lighting system of claim 1, further comprising:
at least one wireless receiver in said at least one LED heat-sink assembly; and
a wireless LED module controller, which can control LED operations wirelessly.

9. The lighting system of claim 8, wherein:
said wireless LED module controller can be controlled by a wireless device chosen from the group consisting of wall mounted units, laptops, PDAs and personal electronic devices.

10. The lighting system of claim 8, wherein:
said wireless LED module controller can be controlled by an astronomical clock system.

11. The lighting system of claim 8, wherein:
said wireless LED module controller can be controlled by input from photo sensors.

12. The lighting system of claim 8, wherein:
said wireless LED module controller can be controlled by input from occupancy sensors.

13. The lighting system of claim 8, wherein:
said wireless LED module controller controls heat-sink assemblies of said lighting system individually.

14. The lighting system of claim 8, wherein:
said wireless LED module controller controls heat-sink assemblies of said lighting system collectively.

15. The lighting system of claim 1, further comprising reflective louvers.

16. The lighting system of claim 15, further comprising:
a wireless LED module controller, which controls operations of said reflective louvers wirelessly.

17. The lighting system of claim 1, further comprising reflective walls.
